(19) United States
(12) Patent Application Publication
(10) Pub. No.: US 2015/0278248 A1
(43) Pub. Date: Oct. 1, 2015

(54) Personal Information Management Service System

(71) Applicant: SAGATEK CO., LTD., Taipei (TW)

(72) Inventors: Jung-Hsiang Chen, Taipei (TW); I-Chun Chen, Taipei (TW); Kuan-Wen Chen, Taipei (TW); Cheng-Szu Chen, Taipei (TW)

(21) Appl. No.: 14/672,971

(22) Filed: Mar. 30, 2015

(30) Foreign Application Priority Data
Apr. 1, 2014 (TW) 103112167

(51) Int. Cl. G06F 17/30; G06K 9/62; G06K 9/00

(52) U.S. Cl. CPC G06F 17/30256; G06F 17/30253; G06K 9/00288; G06K 9/6263

(57) ABSTRACT

The present invention provides a business card image based personal information management service system. The present invention creates a novel personal information management system based on recognition and management of business cards. The present invention allows a user to establish a new personal information file by inputting a business card using a portable device. With a human face image database that includes facial images of a limited number of persons belonging to a defined scope, automatic facial recognition services are provided by the invented system. Facial recognition is automatically processed upon receipt of an input image by user through the portable device.

### FIELD OF THE INVENTION

The present invention relates to a personal information management service system, especially to a system that provides personal information management services to portable device users.

### BACKGROUND OF THE INVENTION

For any businessperson or ordinary person, it is always necessary to manage personal information of one's customers, suppliers, friends etc. by using a personal information management system. Among the commercially available products, there are so-called customer relation management (CRM) systems that use a server to provide customer information management services for their users. Such systems provide strong management capabilities, while their system tends to be complicated and expensive to build and operate; not everyone can afford it.

Personal information management systems based on business card images are known in the market. Such a system can be installed in a PC, uses an optical scanner which is often external, to obtain image of particular persons' business cards. Written information in the business cards is recognized by using the optical character recognition (OCR) technology, so that personal information printed on a business card, such as company name, address, personal name, title, telephone number, email address, etc., may be recorded in a personal information file representing owners of the business cards. The existing OCR technology is able to recognize characters and symbols of a plurality of language and fonts. Although correctness of recognition of the current OCR technology needs certain improvements, it is usable in daily commercial operations. Such personal information management service systems further provide editing tools that allows users to input other information of particular business card owners. Some systems may allow users to input photos and even videos to the personal information files.

Personal information management system for smart phone users also is known in the art. This simple personal information management system uses a simple computer program to provide portable phone users the function of integrating resources that relate to personal information and are stored in the smart phone and store them to a file representing particular persons. Information linked to the personal information files includes written descriptions, images and videos.

Cloud server that provides personal information management services is also known. Such service systems utilize the powerful computing capabilities and storage capacity of the servers to provide the user with the storage of a large number of data.

In the personal information management technology, facial recognition is an emerging technology. Facial recognition can be roughly divided into two levels. The first level is used to identify whether or not an input image includes a “human face.” This technique has been used commercially, for example, to determine whether any person has passed by a specific location, frequency and time duration an electronic billboards is looked at by pedestrians etc. The other level of the technology is used to identify a specific person's face in an image. This technique is mainly used in criminal investigation but further developments are needed before this technology may be widely used. The reason is that there are a huge number of candidate faces to be compared, therefore scope of images to be identified is unlimited. Currently in a variety of social networking sites intensive tests of facial recognition are being conducted, in order to improve the accuracy of identifying. Yet there is no personal information management system that utilizes the facial recognition technology to provide useful information.

### SUMMARY OF THE INVENTION

The purpose of the present invention is to provide a personal information management service system based on business card management technology. Based on a business card image recognition and management technology, a novel personal information management service system is invented. The invented system utilizes a facial image database that includes facial images of limited scope and number of persons to provide facial recognition services. Management of a large quantity of personal information including multiple type of media may be realized by using a portable device.

According to the present invention, the personal information management service system comprises:

a business card management module, including a business card image input interface to receive business card image files input by user from a remote device, to form a part of a newly established personal information file, and a business card image recognition tool to grab text information and graphic information from images contained in the business card image file and to save the text information and graphic information into predetermined fields of the personal information file;

a person Information management module to provide a personal information database to store personal information files established by the business card image input interface and a personal information management interface to allow users to edit, including adding, deleting and modifying, particular personal information files;

the personal information file being configured to include text data, voice data, graphic data and video data; the personal information file being further configured to include image files that include facial images; the personal information management module further automatically generating historical data that include date and location data corresponding to a newly added entry; and

a facial recognition module including a facial feature extraction tool to extract facial features from image files of particular personal information files stored in the personal information database and to store the extracted facial features in corresponding personal information files; a facial image input interface to receive images that include facial images as input by a user from a remote device, to label the input image as a facial image, to extract date of image information and to store the date information in a corresponding personal information file; and a facial recognition tool to automatically compare facial features of an image input by the facial image input interface with facial features of facial images in the personal information files of the personal information database, to obtain a matched facial image with a similarity value greater than a threshold, and, when matched, store the input facial image in the personal information file of the matched facial image.

In a preferred embodiment of the present invention, the facial recognition tool determines similarity of the input facial image and a facial image in the personal information database, according to their respective facial features. The facial image input interface further provides a graphical interface for users to confirm results of determination of the facial recognition tool.

In a preferred embodiment of the invention, the personal information management service system further includes a data search module, to connect an Internet search tool and use the Internet search tool to search information provided in the Internet, using text and/or image information as basis of such search, and to provide search results in an Internet information identification interface so to allow users to input representative information relating to the search results.

The personal information management service system of the present invention may be installed in a cloud server in order to make use of the strong computing power of the server in the recognition of the business card images and the facial images. It also uses the large storage capacity of the server to storage a large quantity of personal information. Users need only to use a personal computer or a portable device to connect to the personal information management service system, in order to manage large amounts of personal information. In addition, because the face recognition tool compares an input facial image only with images stored in the personal information database, a high accuracy rate of facial recognition, sufficient for purpose of personal information management, may be realized.

The above and other objectives and advantages of the present invention may be clearly appreciated from the following detailed description by reference to the following drawings.

### BRIEF DESCRIPTION OF THE DRAWINGS

FIG. 1 shows the systematic diagram of one embodiment of the personal information management service system of the present invention.

FIG. 2 shows a block diagram of one example of the personal information management service system in details.

FIG. 3 shows the flowchart of a method for recognition of facial images by the facial recognition tool of one preferred embodiment of this invention.

### DETAILED DESCRIPTION OF THE INVENTION

In the followings, preferred embodiments of the personal information management service system of the present invention will be described by referring to the drawings.

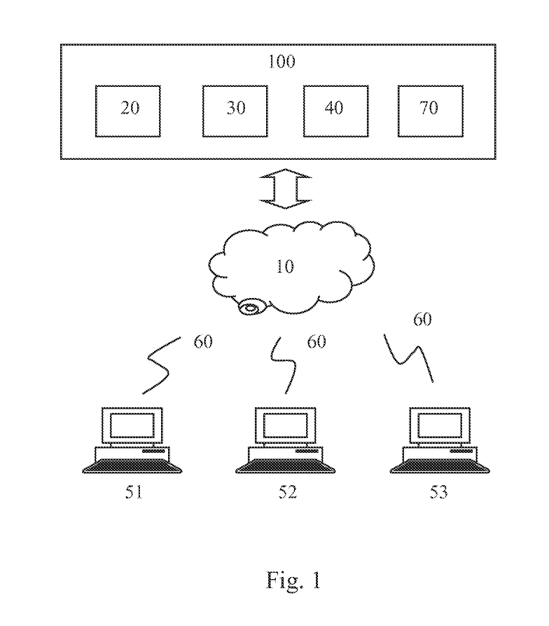

FIG. 1 shows the systematic diagram of one embodiment of the personal information management service system of the present invention. As shown, in the present embodiment, the personal information management service system 100 is installed in a cloud-based server 10. By this way, the strong operation power and the large storage and communication capacities of the cloud server 10 may be utilized to accelerate various necessary processing of the system. Of course, other types of computer equipment may be used to install the personal information management service system 100. However, in such cases the computer equipment must be able to provide sufficient computing, storage and communication capabilities.

As shown in FIG. 1 the personal information management service system 100 includes: a business card management module 20, a person information management module 30 and a facial recognition module 40. Among them, the business card management module 20 is configured to receive business card image input by a remote device, to extract text and graphic information from the received images and to establish personal information files corresponding to providers of the business card images based on the user's instructions. The personal information management module 30 provides users with management and editing functions to the personal information files. The face recognition module 40 provides a facial image recognition tool to recognize facial images input by users. In the design of the present invention, the face recognition module 40 mainly compares or matches an input facial image with images already stored in a personal information database, to generate matching results and provides the matching results for users to confirm.

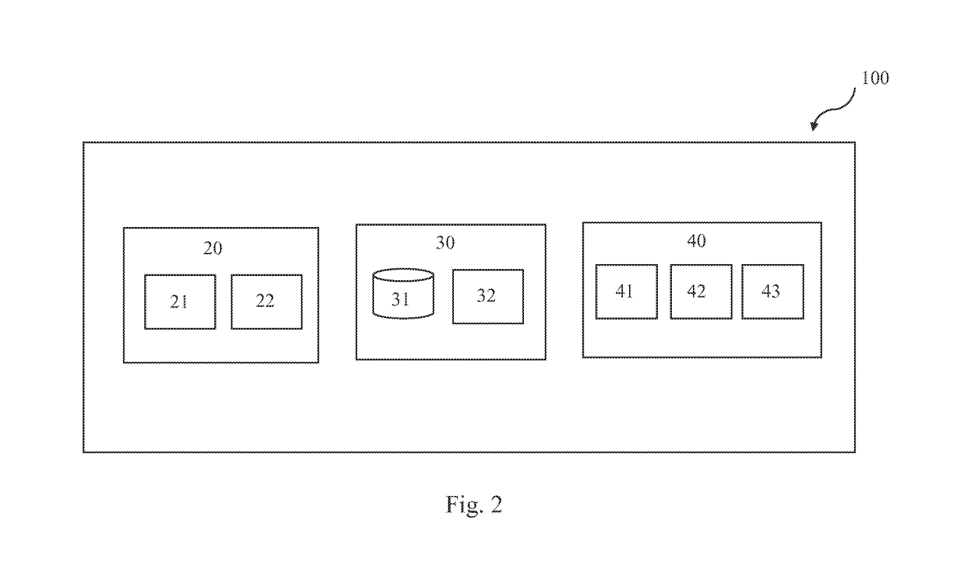

FIG. 2 is block diagram of one embodiment of the personal information management service system of this invention, with further details. The business card management module 20 shown in FIG. 2 corresponds to the business card management module 20 of FIG. 1. In this embodiment, the business card management module 20 includes: a business card image input interface 21 for receiving business card image files input by user from remote devices 51, 52, 53, as a part of a newly established personal information file; a business card image recognition tool 22 to extract text and graphic data from the input business card images and to store the text and graphic data in predetermined fields of the personal information file, according to natures of the data. In this embodiment, the business card image input interface 21 may provide an image input page, presented in a screen of the remote devices 51, 52, 53 for the users to input business card image files to be recognized from the remote devices 51, 52, 53 to the card management module 20 through network connections 60, 60. However, in other embodiments, e.g., the case where the personal information management service system 100 is installed in a stand-alone computer, the business card image input interface 21 can be as simple as an input interface. The business card image file as input may include any commonly used format of image file, as long as the format is supported by the input interface 21. Applicable card image formats include JPEG, etc. Sources of the business card image files are not limited. They can be an existing file stored in the memory device (not shown) of the remote devices 51, 52, 53, or a business card image file captured by a digital camera, an image scanner, a network camera etc. In the commercially available products, there are “business card management systems” that provide a specific business card scanner, as well as tools to identify business card images. Business card image file obtained by such systems may also be used as the input business card image file in the present invention.

In the application of the invention, the remote devices 51, 52, 53 may be any computer device with communication capabilities, including desktop computers, laptops, smart phones, tablet computers etc. Other portable devices or fixed devices can also be used in the present invention, as long as they can establish communication with the personal information management service system 100.

According to preferred embodiments of the present invention, the business card image input interface 21 may provide a graphical user interface, displayed on the remote devices 51, 52, 53 for the user to input business card images. The graphical interface provides dragging or button to allow users to add or download load business card image files. Control buttons may also be provided for users to turn on a network camera or an image scanner to capture images of a business card, and to convert the captured image files into a suitable format. The graphical user interface can also allow users to enter names of owner of the business cards or other representative information, so to establish a new personal information files. In the preferred embodiment of the invention, the business card image input interface 21 may retrieve recognition information generated by the business card image recognition tool 22, such as names of business card holders, and automatically show the recognition information in specific fields of the graphical user interface for users to confirm.

When a user has established a personal information file, the business card image recognition tool 22 is actuated automatically or manually, to recognize contents included in the business card image file. Typically, information on a business card would include text information, such as name of business cards provider, company name, job title, address, phone number, e-mail address, as well as graphic information, such as company logo and photo of business card provider. In the prior art, separating text information from graphic information contained in the business card image file and recognition of text information separated have become a matured technology. It is easy for those having ordinary skills in the art to use or modify the existing technology and use the text information recognition technology in the business card image recognizable tool 22 of the present invention. Further, the “business card management systems” described above are also valuable for reference. Results of recognition by the business card image recognition tool 22 will include: image of the business card, provider's name, company name, job title, address, phone number, e-mail address, as well as company logo and photo of provider. They are all stored in specific fields of the personal information file so established. A personal information file corresponding to the provider of the business card is thus established. Information contained in the personal information file would also include date and time and/or location of the file, if the business card image capture device is provided with a global positioning system (GPS) and records the location information in the business card image file.

In the preferred embodiments of the invention, the business card image input interface 21 further displays recognition results of the business card image recognition tool 22 in the graphical user interface, for the user to confirm. The personal information file so established is stored in the personal information database 31 of the personal information management module 30.

A personal information file established by the business card image input interface 21 and the business card image recognition tool 22 would include basic personal information and a plurality of fields that is left blank. In order to provide users the possibility of editing the personal information files, including addition, deletion and modification, as shown in FIG. 2, the personal information management module 30 provides a person information database 31 for storing the personal information files established by the business card image input interface 21 and a personal information management interface 32 for the user to edit particular personal information files from the remote devices 51, 52, 53. In a preferred embodiment of the invention, the personal information management interface 32 provides a graphic interface, displayed on the remote devices 51, 52, 53, for users to edit the contents of selected personal information files.

Based on such designs, the personal information management interface 32 may provide in its graphical user interface predetermined fields, with field names and contents. Users are allowed to input new data into the fields that are left blank or correct, amend data in fields that are already filled with dat. The newly added data are stored by replacing the original data, with date of edition being recorded as well. The date of edition provides historical records for the name, profession, address, telephone number etc. of particular persons. Data acceptable and editable in the respective fields may include all types of information, such as text, sound/voice, image and video information. In addition to the date and time of edition, place of edition may also be included by obtaining the GPS information provided by the file or a device, such as the remote device 51, 52, 53. All these data are stored in the corresponding fields of the personal information file. It is appreciated that those having ordinary skills in the art may use the commercially available database management software to provide these functions, with necessary modifications. Details thereof are thus omitted.

After the edition, addition or correction by a user, the edited personal information file is stored in the personal information database 31. The personal information management interface 32 further provides a graphic interface for users to browse information included in particular personal information files. Generally speaking, this function may be provided by the personal information management interface 32, in its edition page. It is important that the personal information management interface 32 should provide a search tool for users to search in the personal information database 31, which will be described in more details below.

In the design of the present invention, the personal information database 31 is required to provide the capacity to store image files containing images of human faces. In the personal information database 31, the individual personal information files are provided with fields that are able to store image files containing a facial image. The “image files containing a facial image” referred hereto denotes to an image file that is labeled with “facial image.” In order to provide such indication, the personal information database 31 may be so designed, that fields that may contain a facial image are labeled as a field of facial image. By doing so, the system may automatically obtain image files that contain a facial image from the personal information database 31. As to the labeling, a facial image may be labeled by a user according to the user's determination or by the system through an automatic facial recognition technology. In one preferred embodiment of the present invention, a facial image file may be set as representative image of the respective personal information files. The representative image preferably includes as many facial features as possible of a person. This, of course, may be selected by a user or by the system automatically. In the conventional art, it is possible to first determine a particular file is an image file by the attributes information included in the file and to recognize whether the image includes a human face, followed by labeling the file as a facial image. Such automatic facial recognition is already a mature technology and is known to those having ordinary skills in the art. In addition, the conventional art also provides the technology to analyze a facial image to determine its quality and select from among a plurality of facial image the facial image that includes the highest quantity or best quality of facial features. Those having ordinary skills in the art are able to select an applicable technology from the commercially available products, with necessary modifications, to conduct the analyses and determinations. Details thereof are thus omitted.

As further shown in FIG. 2, in the personal information management service system 100 of the present invention, the facial recognition module 40 includes: a facial feature extraction tool 41 to extract facial features from image files of particular personal information files stored in the personal information database 31 and to store the extracted facial features in corresponding personal information files; a facial image input interface 42 to receive facial images input by a user from a remote device, to extract date of image information and to store the date information in a corresponding personal information file; and a facial recognition tool 43 to automatically compare facial features of an image input by the facial image input interface 42 with facial features of facial images in the personal information files of the personal information database 31, to obtain a matched facial image with a similarity value greater than a threshold, and, when matched, store the input facial image in the personal information file of the matched facial image.

Although it is not desired to limit present invention by any theory, according to the present invention, the conventional facial recognition technology is not useful in criminal investigations, because in most applications of that nature, a facial image shall be compared with a large quantity of facial images, in order to generate a match determined according to their similarity values. However, if in an application a facial image is only required to compare with a small quantity of facial images within a limited scope, the conventional facial recognition technology would suffice.

While a variety of techniques in the identification of faces has been proposed, facial recognition based on features extracted from facial images has the advantage of higher speed. In addition, some proposed to use common features extracted from a plurality of facial images that represents the face of the same person in facial recognition. Such approach is valuable for reference. Of course, there are other proposals that do not use features extracted from the facial images. They are also applicable in this invention.

In the preferred embodiments of the invention, the facial recognition module 40 provides a facial feature extraction tool 41, to extract facial features from the facial image files stored in the personal information database 31 and store the results of results in the corresponding personal information files. To achieve this purpose, the facial feature extraction tool 41 may obtain from the personal information database 31 an image file that is labeled as facial images, identify a facial image or part of an image that contains a face and extract facial features from such image or image part. In application, it is possible to extract the facial features of a person from the representative image or to extract common features from a plurality of facial images that represent the same person. Features to be exacted may be those specified in known industrial standards or those defined by particular researcher or researching groups. Quantity of the facial features is not limited. Generally speaking, quantity of the facial feature shall not be too small to achieve correct recognition or too large to impact the recognition speed. It may be determined in accordance with purpose or needs in particular applications of this invention.

The facial features extracted by the facial feature extraction tool 41 are stored in the personal information file corresponding to owner of the face in particular format, for further use.

The facial recognition module 40 of the present invention also provides a facial image input interface 42 to accept image files containing a facial image input by remote devices 51, 52, 53. For example, the facial image input interface 42 may provide a graphical user interface displayed on the remote devices 51, 52, 53, in order for users to take a photo, scan a photo or obtain a photographic file, and provide the obtained photo to the facial recognition tool 43. The photo being obtained is displayed in the graphical user interface. The facial image input interface 42 further obtains date, time, location etc. information and based on the result of determination of the facial recognition tool 43, stores the photo file in a corresponding personal information file in the personal information database 31. For example, if result of determination of the facial recognition tool 43 shows the face contained in the obtained photo belongs to a particular person, the photo file is saved to the personal information file designated to that particular person.

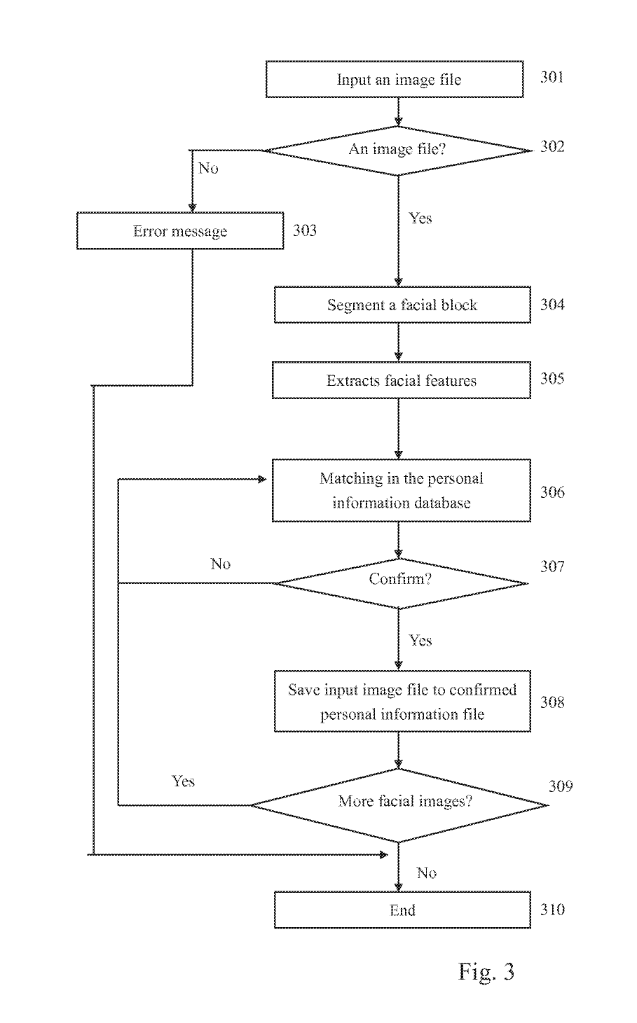

The facial recognition tool 43 of the facial recognition module 40 is configured to automatically execute a facial recognition operation upon the input of an image file that contains a facial image by the facial image input interface 42. FIG. 3 shows the flowchart of a method for recognition of facial images by the facial recognition tool of one preferred embodiment of this invention. As shown, in this example, at step 301 a user inputs an image file from the facial image input interface 42. This event is provided to the facial recognition tool 43 by the facial image input interface 42. At step 302, the facial recognition tool 43 first determines whether the input file is an image file. If the determination is false, it provides an error message to the facial image input interface 42 at step 303, which shows the error message in the graphical user interface and requests the user to input relative information, for saving the input file into a corresponding personal information file. To identify an image file, there are a variety of usable technologies being published or provided in the market. For example, it is possible to determine most image files according to the attribute information, such as filename extensions, included in the files. If the determination is true, at step 304 the facial recognition tool 43 segments the image file, to obtain a block image or blocks of image that include a human face. Segmentation of an image file in order to extract a region in the image file that includes a human face is a known art in the technical field.

Then, at step 305 the facial recognition tool 43 extracts facial features contained in the facial image block or blocks. The facial features so extracted are preferably those having the same definition as the facial features extracted by the facial feature extraction tool 41, so to facilitate facial recognition. It is also possible for the facial recognition tool 43 to use the facial feature extraction tool 41 in the extraction of the facial features. In certain particular embodiments of this invention, the facial recognition tool 43 does not use facial features in the facial recognition. In such embodiments, this step 305 is not used. At step 306, the facial recognition tool 43 compares an image block with all facial images included in the personal information database 31, to calculate their similarity. In some embodiments of this invention, the facial recognition tool 43 compares the block image with the representative images of the respective personal information files. In other embodiments, the facial recognition tool 43 compares the block image with a plurality of facial images stored in the respective personal information files. In addition, in a preferred embodiment, the facial recognition tool 43 compares the facial features obtained in step 305 with the facial features or the common facial features included in the respectively personal information files. As described above, to compare two facial images and to calculate their similarity value are a known art in the technical field. The existing technology is sufficient to provide correct matching results, if the comparisons are used for a small number of images within a limited scope. Those having skills in the art are able to use the commercially available technology or products, possibly with necessary modifications, to determine whether the block image contains a face similar to the face of a person corresponding to particular personal information file in the personal information database 31.

In step 307, the facial recognition tool 43 displays facial images that generate similarity values greater than a threshold in the graphical user interface of the facial image input interface 42, for user to confirm. Shown in the graphical user interface may be the block image or the input image and results of the facial recognition, such as the matched images and name of owner as recorded in the corresponding personal information files. In some embodiments, a plurality of matched images is shown, so that the user may select one of them to confirm. In some other embodiments, however, only one matched image is shown. If the user inputs a “wrong match” message, the step returns to 306 and the facial recognition is repeated. Alternatively, the facial recognition tool 43 may also provide an input window for the user to input name or other information of owner of the input facial image, so that the facial recognition tool 43 saves the input facial image into the corresponding personal information file directly. If training of the facial recognition tool 43 is necessary, certain parameter adjustment tools for image block segmentation, brightness of image, contrast value of image etc. may be provided, for the user to adjust. Facial recognition is repeated and results of training are recorded for further use. If the user inputs a “correct match” message or a selection, at step 308 the facial recognition tool 43 saves the input facial image into a personal information file corresponding to the result of facial recognition, such as the personal information file of a person being identified as owner of the facial image.

In step 309, the facial recognition tool 43 determines whether further facial image blocks need to be recognized. If yes, the step returns to 306; otherwise, the step ends at 310.

As described above, the present invention provides a business card image management technology based personal information management service system. The present invention utilizes the powerful cloud computing capability and storage capacity and develops a personal information management service system based on business card recognition and management technologies. The facial recognition technology useful for matching of facial images in a relatively small quantity and within a limited scope, such as in a facial image database enables the present invention to provide facial image recognition services. To establish a new personal information file, a user needs only to use a portable device to input the image of a business card. The personal information file so established would provide basic information of provider of the business card. To correct or update information or provide historical data, the user may edit the personal information file by adding new data or editing its contents. Data acceptable and editable in the personal information files include text, image, voice, video etc. data. It is also possible to save other types of information such as hyperlinks and web pages. The personal information management service system of the present invention also provides users the functions of automated facial recognition and filing, when an image is input by the user using a portable device. Information contained in an image file may include personal information of a person and date and location of the photographic image. The present invention provides a personal information management service system that is able to process a large quantity of personal information in various media. It provides a very convenient approach for users to establish personal information files. When a user inputs a photographic image that contains a face, the image will be automatically saved to a correct personal information file.

In a preferred embodiment of the invention, the personal information management service system 100 further includes a data search module 70, to connect an Internet search tool. The data search module 70 uses the text information or facial information obtained by the business card image recognition tool 22 and/or the facial feature extraction tool 41 as keywords or key images to search related data files in the Internet through the Internet search tool and automatically saves the search results into the corresponding personal information file. The Internet search tool useful in this invention include any search tool that provides search functions for text, graphic or other type of information in the Internet. It is of course possible to provide an Internet information identification interface (not shown) for the user to determine whether particular search results are relative or correct. In the Internet information identification interface the user is also allowed to input representative information or other information for each search result. In addition, in the technical field of research automation, certain keyword generation tools have been provided, to extract keywords from a plurality of collected articles. Such tools are also useful in this invention, in the determination of whether a search result is relative or correct. If a search results contains an image file, the image file may also be provided to the facial recognition tool 43 for facial recognition. Results of facial recognition are used in the determination of whether a search result is relative or correct.

The above-described embodiment is able to expand the scope and quantity of information collectable by the personal information management service system 100 and the search may be conducted in background, to generate richer results.

1-18. (canceled)

19. A personal information management service system, comprising:
a business card management module, including a business card image input interface to receive business card image files input by a user from a remote device, to form a part of a newly established personal information file, and a business card image recognition tool to grab text information and graphic information from images contained in the business card image file and to save the text information and graphic information into predetermined fields of the personal information file;
a person Information management module to provide a personal information database to store personal information files established by the business card image input interface and a personal information management interface to allow the user to edit particular personal information files; the personal information file being configured to include image files that include facial images; and
a facial recognition module including a facial image input interface to receive images that include facial images as input by the user from a remote device, to extract date of image information and to store the date information in a corresponding personal information file; and a facial recognition tool to automatically compare an image input by the facial image input interface with facial images in the personal information files of the personal information database, to obtain a matched facial image with a similarity value greater than a threshold, and, when matched, to store the input facial image in the personal information file of the matched facial image.

20. The personal information management service system of claim 19, wherein edition functions provided by the personal information management interface include addition, deletion and correction of information.

21. The personal information management service system of claim 19, wherein the personal information database is configured to store text data, voice data, graphic data and video data.

22. The personal information management service system of claim 19, wherein the personal information management module further provides historical information addition function, characterized in that, when an new entry is added to particular personal information file, its corresponding existing entry is not modified, while date and location of the new entry and its relation with the corresponding existing entry are saved.

23. The personal information management service system of claim 19, wherein the facial recognition module further includes a facial feature extraction tool to extract facial features from image files of particular personal information files stored in the personal information database and to store the extracted facial features in corresponding personal information files.

24. The personal information management service system of claim 23, wherein the facial recognition tool determines the input facial image and facial images stored in the personal information files of the personal information database according to their facial features.

25. The personal information management service system of claim 19, wherein the facial recognition module further includes a facial feature extraction tool to extract facial features from a predetermined image file in personal information files stored in the personal information database and to store the extracted facial features in corresponding personal information files.

26. The personal information management service system of claim 25, wherein the facial recognition tool determines the input facial image and facial images stored in the personal information files of the personal information database according to their facial features.

27. The personal information management service system of claim 19, wherein the facial image input interface further provides a graphical interface for user to confirm correctness of a determination of the facial recognition tool.

28. The personal information management service system of claim 23, wherein the facial image input interface further provides a graphical interface for user to confirm correctness of a determination of the facial recognition tool.

29. The personal information management service system of claim 25, wherein the facial image input interface further provides a graphical interface for user to confirm correctness of a determination of the facial recognition tool.

30. The personal information management service system of claim 19, wherein the facial image input interface further obtains location information included in the image file.

31. The personal information management service system of claim 23, wherein the facial image input interface further obtains location information included in the image file.

32. The personal information management service system of claim 25, wherein the facial image input interface further obtains location information included in the image file.

33. The personal information management service system of claim 19, wherein the facial image input interface receives images containing a face as input by the user from a remote portable device.

34. The personal information management service system of claim 23, wherein the facial image input interface receives images containing a face as input by the user from a remote portable device.

35. The personal information management service system of claim 25, wherein the facial image input interface receives images containing a face as input by the user from a remote portable device.

36. The personal information management service system of claim 19, further comprising a data search module to connect an Internet search tool and use the Internet search tool to search information provided in the Internet, using text and/or image information as basis of such search.

37. The personal information management service system of claim 36, wherein the data search module further provides an Internet information identification interface for the data search module to display search results in the Internet information identification interface for the user to input representative information of particular personal information files.

38. The personal information management service system of claim 23, further comprising a data search module to connect an Internet search tool and use the Internet search tool to search information provided in the Internet, using text and/or image information as basis of such search.

39. The personal information management service system of claim 38, wherein the data search module further provides an Internet information identification interface for the data search module to display search results in the Internet information identification interface for the user to input representative information of particular personal information files.

40. The personal information management service system of claim 25, further comprising a data search module to connect an Internet search tool and use the Internet search tool to search information provided in the Internet, using text and/or image information as basis of such search.

41. The personal information management service system of claim 40, wherein the data search module further provides an Internet information identification interface for the data search module to display search results in the Internet information identification interface for the user to input representative information of particular personal information files.
